(19) United States
(12) Patent Application Publication
(10) Pub. No.: US 2026/0215392 A1
(43) Pub. Date: Jul. 30, 2026

(54) Multi-Purpose Animal Enclosure Device

(71) Applicant: Nathan Ferenczy, Staten Island, NY (US)

(72) Inventor: Nathan Ferenczy, Staten Island, NY (US)

(21) Appl. No.: 19/459,248

(22) Filed: Jan. 26, 2026

Related U.S. Application Data
(60) Provisional application No. 63/750,836, filed on Jan. 29, 2025.

(51) Int. Cl. A01K 1/03; A01K 1/00; A01K 1/01; F21V 23/04; F21V 33/00; B43L 1/00

(52) U.S. Cl. CPC A01K 1/03; A01K 1/0082; A01K 1/01; F21V 23/04; F21V 33/00; B43L 1/00

(57) ABSTRACT

A multi-purpose animal enclosure device is provided. The device includes structural, functional, and environmental features designed for reptiles and small animals. A bottom frame supports a transparent or screened body and includes sidewalls for attaching a writing surface, integrated power outlets, and a timer-controlled lighting system. A quick-detach drainage point connects to a hose for easy maintenance. The enclosure body features a lockable access door with a waterproof seal. A top frame supports misting system tubing with adjustable heads, a magnetically sealed lid, and a ventilated screen, and also includes a humidifier hose port with an escape-prevention barrier. Repositionable interior surfaces attach to built-in receiving points for habitat customization. Integrated lighting elements in the top frame further provide UVB, LED, or heat lighting, controllable via buttons or automated through the timer system.

### CROSS-REFERENCE TO RELATED APPLICATION

The present application claims priority to, and the benefit of, U.S. Provisional Application No. 63/750,836, which was filed on January 29, 2025, and is incorporated herein by reference in its entirety.

### FIELD OF THE INVENTION

The present invention relates generally to the field of animal enclosures. More specifically, the present invention relates to a multi-purpose animal enclosure device that integrates structural support, environmental controls, and customizable features to house reptiles and other small animals. Accordingly, the present disclosure makes specific reference thereto. Nonetheless, it is to be appreciated that aspects of the present invention are also equally applicable to other like applications, devices, and methods of manufacture.

### BACKGROUND

The care and maintenance of reptiles and other small animals in domestic environments pose unique challenges due to the specific environmental conditions required for their health and survival. Reptiles specifically are ectothermic animals that rely on external sources of heat and light to regulate their body temperature and metabolic functions. A deficiency in proper lighting and appropriate thermal gradients can result in severe physiological complications, including metabolic bone disease, organ failure, and death. Conventional enclosures currently available lack integrated systems that address these critical requirements efficiently. As a result, users must frequently rely on external equipment, which can be cumbersome to install and manage. This reliance increases the likelihood of inconsistent care, particularly with regard to lighting schedules and humidity control, which are essential to reptile well-being. Furthermore, the absence of modular features in most existing enclosures limits adaptability for various species with differing habitat needs. In addition, the inconvenience of manual tracking and limited drainage solutions further complicates maintenance, deterring potential pet owners and reducing overall animal welfare. As a result, there is a strong demand for a solution that integrates environmental control, structural flexibility, and user convenience into a single enclosure.

Therefore, there exists a long-felt need in the art for a multi-purpose animal enclosure device that provides integrated lighting and thermal management features suitable for reptiles and similar animals. There also exists a long-felt need in the art for a multi-purpose animal enclosure device that includes modular and customizable interior configurations adaptable to a range of species and care requirements. Moreover, there exists a long-felt need in the art for a multi-purpose animal enclosure device that facilitates simplified maintenance through integrated drainage and environmental automation systems.

The subject matter disclosed and claimed herein, in one embodiment thereof, comprises a multi-purpose animal enclosure device. The device is comprised of a multi-purpose animal enclosure device that comprises structural, functional, and environmental control features tailored to the housing of reptiles and other small animals. The device comprises a bottom frame member serving as a structural base to support a transparent or screen-based enclosure body, with integrated sidewalls capable of receiving a writing surface for annotating care information. The bottom frame member further comprises power outlets supplied via an integrated power cord, and a timer module with interval controls for automating internal lighting cycles. A drainage system comprises a quick-detach receiving point configured for fluid communication with the body and accepts a hose via a coupling mechanism. The body comprises transparent or screen panels with an access door mounted on an articulating member and sealed with a waterproof gasket, secured by a lockable mechanism. The top frame defines the perimeter of the upper body and receives misting system tubing with adjustable misting heads for humidity control. Embedded magnets and clamp-style fasteners secure a lid, which includes a screen for ventilation and escape prevention. A receiving area in the top frame accepts a humidifier hose via an adapter and includes a perforated barrier to prevent escape. The interior space includes receiving points for attaching an artificial interior surface that is repositionable and compatible with habitat accessories. Integrated lighting elements within the top frame comprise UVB, LED, or heat lamps and are controllable by buttons or linked to the timer for automated cycles.

In this manner, the multi-purpose animal enclosure device of the present invention accomplishes all the foregoing objectives and provides a multi-purpose animal enclosure device that integrates lighting and thermal regulation components directly into the enclosure, thereby supporting the specific environmental needs of reptiles and similar animals. The inclusion of repositionable interior surfaces and multiple receiving points further provides modular adaptability to accommodate a wide variety of species and habitat configurations. The integrated power delivery, humidity control systems, and drainage functionality simplify ongoing maintenance tasks and reduce the burden on the user. Together, these features resolve the limitations of existing enclosures by offering a comprehensive, customizable, and efficient solution that improves the standard of care for small animals housed in domestic settings

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-purpose animal enclosure device. The device is a reptile or animal enclosure comprising structural, functional, and environmental components designed to support animal containment and care.

The enclosure is comprised of a bottom frame member serving as a structural base for a transparent or screened body forming the main housing area. The bottom frame member includes a side wall configured to receive a writing surface that allows user annotation of species information, feeding schedules, or environmental data.

The bottom frame is further comprised of electrical components including multiple power outlets, an integrated power cord, a timer module with adjustable controls, and a manual on/off switch. These components supply and regulate power to internal lighting and other connected accessories. A quick detach receiving point is integrated into the bottom frame and configured for fluid communication with the enclosure interior. The receiving point accepts a drainage hose via a quick connector to enable water drainage and filling.

The body is comprised of transparent materials such as glass or acrylic panels, or alternatively, a screened material. A door is included and is mounted on an articulating member. A lockable securing mechanism and waterproof gasket are included for security and moisture control.

The upper portion of the body is comprised of a top frame defining the upper edge. The top frame includes a recessed channel configured to receive tubing with misting heads equipped with adjustable nozzles for interior humidity control. Magnets are embedded or surface-mounted mounted along the top surface of the frame and align with corresponding magnets on the bottom surface of a lid to form a sealed contact. The lid also includes clamp-style fasteners and a mesh screen framed for tension to ensure airflow, prevent escape, and resist deformation. A receiving area is integrated into the top frame to accept a humidifier hose through an adapter coupling inserted into an opening in the lid. The bottom wall of the receiving area is covered with a barrier allowing air passage while preventing escape.

The interior of the body includes receiving points in the form of channels or brackets to accept an artificial surface. The artificial surface engages with the receiving points using a fastener and may be repositioned. The surface supports habitat elements and may be made from textured plastic or other suitable materials.

The bottom surface of the top frame is further comprised of integrated lighting elements, including UVB bulbs, LED arrays, or heat lamps. The lighting elements are controlled manually by at least one button or through the timer module for automated operation.

Accordingly, the multi-purpose animal enclosure device of the present invention is particularly advantageous as it provides a multi-purpose animal enclosure device that integrates lighting and thermal regulation components directly into the enclosure, thereby supporting the specific environmental needs of reptiles and similar animals. The inclusion of repositionable interior surfaces and multiple receiving points further provides modular adaptability to accommodate a wide variety of species and habitat configurations. The integrated power delivery, humidity control systems, and drainage functionality simplify ongoing maintenance tasks and reduce the burden on the user. Together, these features overcome the limitations of existing enclosures by offering a comprehensive, customizable, and efficient solution that improves the standard of care for small animals housed in domestic settings

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multi-purpose animal enclosure device of the present invention in accordance with the disclosed architecture;

FIG. 2 illustrates an enhanced perspective view of a bottom portion of one potential embodiment of a multi-purpose animal enclosure device of the present invention in accordance with the disclosed architecture;

FIG. 3 illustrates an enhanced perspective view of a bottom portion of one potential embodiment of a multi-purpose animal enclosure device of the present invention in accordance with the disclosed architecture;

FIG. 4 illustrates a top perspective view of one potential embodiment of a multi-purpose animal enclosure device of the present invention with the lid attached in accordance with the disclosed architecture;

FIG. 5 illustrates a top perspective view of one potential embodiment of a multi-purpose animal enclosure device of the present invention with the lid unattached in accordance with the disclosed architecture; and

FIG. 6 illustrates a perspective exploded view of an artificial surface of one potential embodiment of a multi-purpose animal enclosure device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multi-purpose animal enclosure device that provides integrated lighting and thermal management features suitable for reptiles and similar animals. There also exists a long-felt need in the art for a multi-purpose animal enclosure device that includes modular and customizable interior configurations adaptable to a range of species and care requirements. Moreover, there exists a long-felt need in the art for a multi-purpose animal enclosure device that facilitates simplified maintenance through integrated drainage and environmental automation systems.

The present invention, in one exemplary embodiment, is comprised of a multi-purpose animal enclosure device. The device incorporates structural, functional, and environmental control elements designed for housing reptiles and other small animals. A bottom frame member functions as the structural base, supporting a transparent or screened enclosure body. Integrated sidewalls are configured to hold a writing surface, enabling annotation of animal care information.

The bottom frame includes built-in power outlets connected through an integrated power cord, along with a timer module equipped with interval controls to automate lighting cycles. A drainage system includes a quick-detach receiving point in fluid communication with the enclosure body, designed to accept a hose via a coupling mechanism for efficient water management.

The enclosure body is comprised of transparent or screened panels and includes an access door mounted on an articulating member. The door is sealed with a waterproof gasket and secured using a lockable mechanism to maintain safety and moisture control.

The top frame outlines the upper perimeter of the body and accommodates misting system tubing with adjustable misting heads to regulate humidity. Magnets embedded in the top frame and clamp-style fasteners are used to secure a lid, which incorporates a screen for ventilation and prevention of animal escape.

A dedicated receiving area within the top frame is designed to accept a humidifier hose through an adapter coupling inserted into the lid, with a perforated barrier installed to block animal escape while allowing airflow.

The interior includes multiple receiving points designed for attachment of an artificial interior surface. This surface is repositionable and compatible with habitat accessories, offering flexible configuration options.

Lighting components integrated into the underside of the top frame include UVB bulbs, LED arrays, or heat lamps, which may be controlled manually through buttons or automatically via the timer module for scheduled operation.

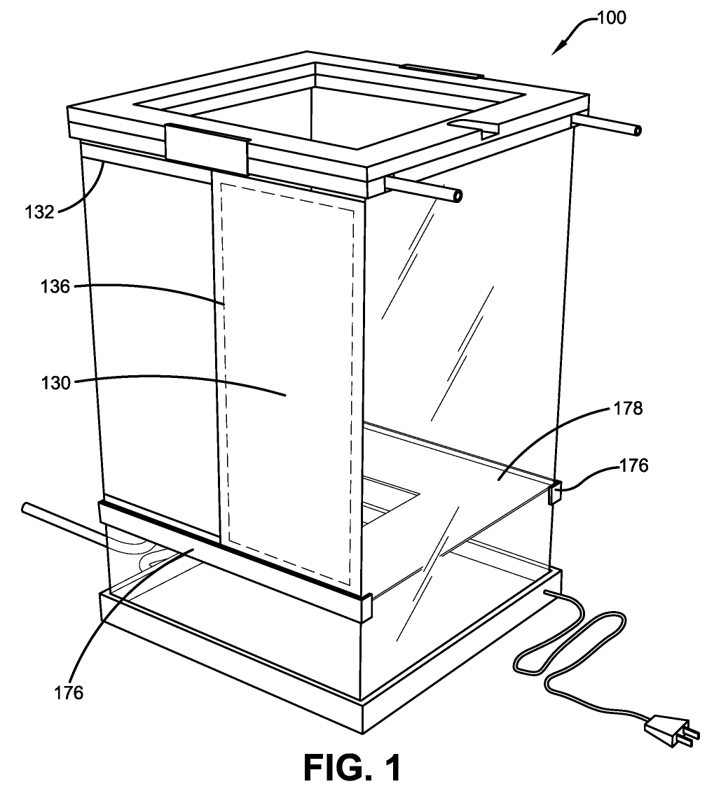

Referring initially to the drawings, FIG. 1 illustrates a perspective view of one potential embodiment of a multi-purpose animal enclosure device 100 of the present invention in accordance with the disclosed architecture. The device 100 is a reptile (or other animal) enclosure comprising structural, functional, and environmental components tailored to support the containment and care of reptiles (or other animals).

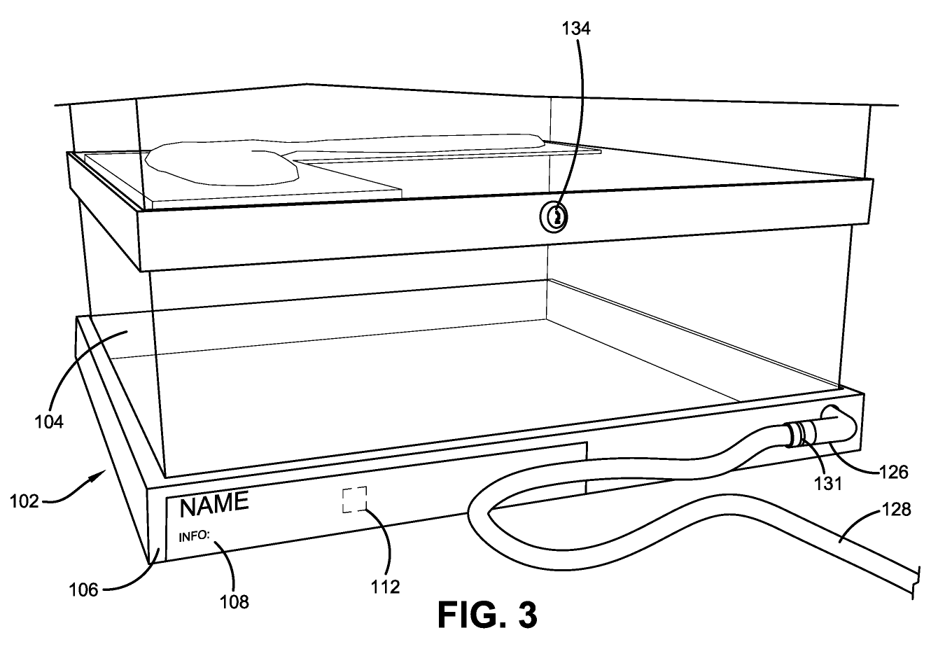

The device 100 may be comprised of a bottom frame member 102 serving as a structural base to support the body 104 of the device which forms the living enclosure. The bottom frame member 102 may be further comprised of a side wall 106 configured to receive a writing surface 108 such as but not limited to a dry erase surface, chalkboard surface, magnetic label board, or reusable adhesive panel, as seen in FIG. 3. The writing surface 108 may be secured to the side wall 106 using a fastener 112 such as but not limited to magnetic attachment, slide-in track, adhesive strip, or mechanical clip. The writing surface 108 enables a user to annotate species information, feeding schedules, or environmental data directly on the device 100.

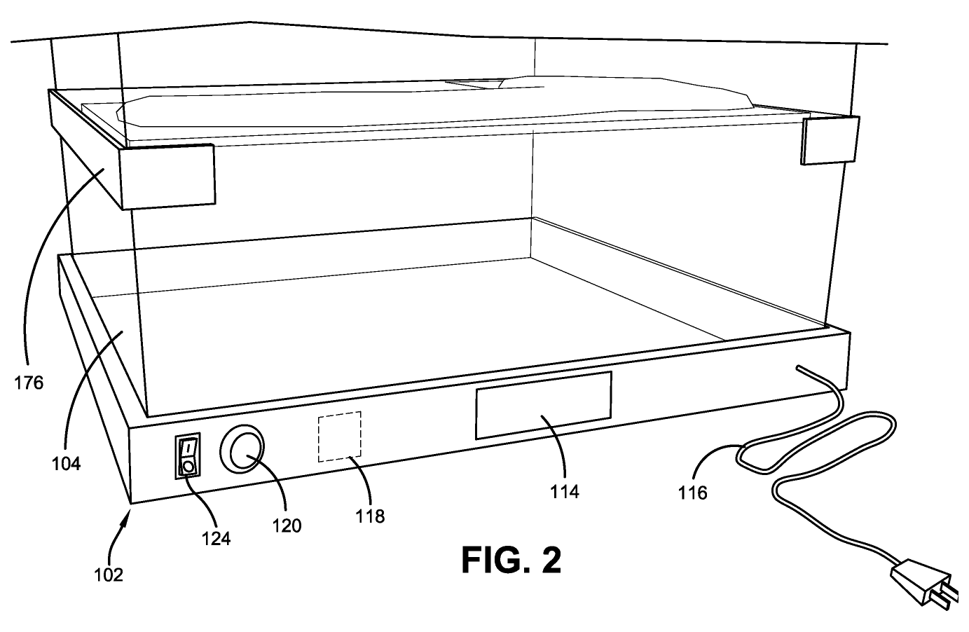

The bottom frame member 102 may also be comprised of electrical components to support powered accessories directly from the device 100. More specifically, a plurality of power outlets 114 may be provided to supply electricity to connected equipment that may be used in caring for the reptile or other animal. An integrated power cord 116 may be permanently affixed to the frame 102 to deliver power to the outlets 114, as seen in FIG. 2. A timer module 118 with adjustable interval controls 120, such as but not limited to selector switches, may operate in conjunction with the outlets 114 and internal lighting 182 to automate cycles for durations such as but not limited to 6 hours, 12 hours, 18 hours, or 24 hours. An on/off switch 124 may be positioned on the bottom frame 102 to allow manual override of lighting and power functions.

A quick detach receiving point 126 may also be integrated into the bottom frame 102 and is configured to be in fluid communication with the interior of the body 104. The receiving point 126 may accept a drainage hose 128 via a quick connector 131 such as but not limited to a snap fit, threaded, or cam lock coupling mechanism to facilitate draining and filling of the body 104.

The body 104 may preferably be comprised of transparent material such as but not limited to annealed glass, tempered safety glass, or impact-resistant acrylic panels. In a further embodiment, the body 104 may be comprised of a screen material. The body 104 may include a door 130 such as but not limited to a sliding panel, hinged swing-out panel, or an upward pivoting access panel. The door 130 may be mounted on an articulating member 132 such as a rail, hinge, or pivot axis integrated into the body 104 structure, as seen in FIG. 1. The door 130 may be lockable via a securing mechanism 134 such as but not limited to a keyed cylinder lock, combination latch, magnetic catch, or sliding bolt. For moisture control, the door 130 may be further comprised of a waterproof gasket 136 that forms a water-tight seal around the door 130 when the door 130 is closed.

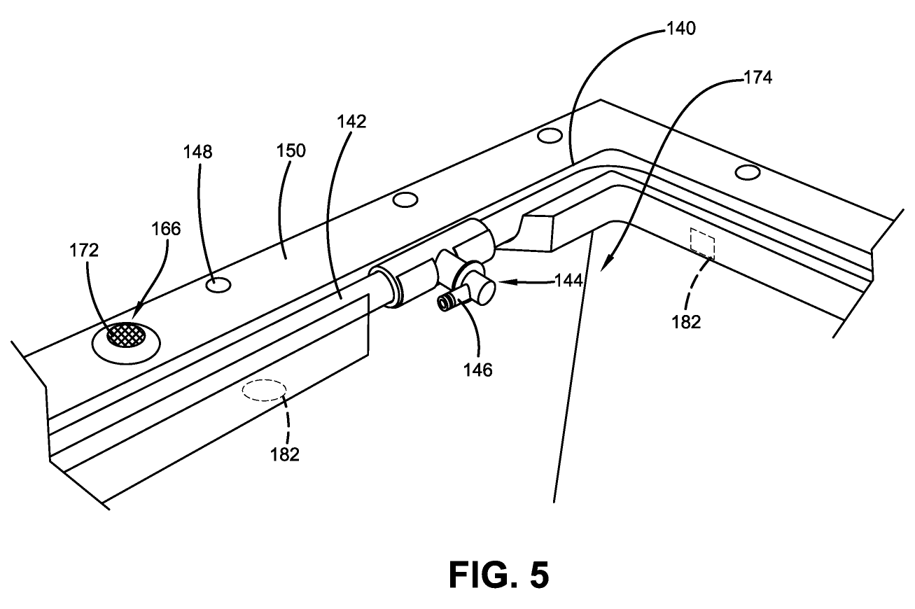

The upper portion of the body 104 may be comprised of a top frame 138 defining the perimeter of the upper edge of the body 104. The top frame 138 may be comprised of a recessed or molded channel 140 configured to receive tubing 142 equipped with misting heads 144, as seen in FIG. 5. The misting heads 144 may be embedded or externally attached to the tubing 142 and may include features such as but not limited to, adjustable nozzle heads 146. The heads 146 may be positioned to deliver directed mist to and within the interior of the body 102 to maintain humidity levels.

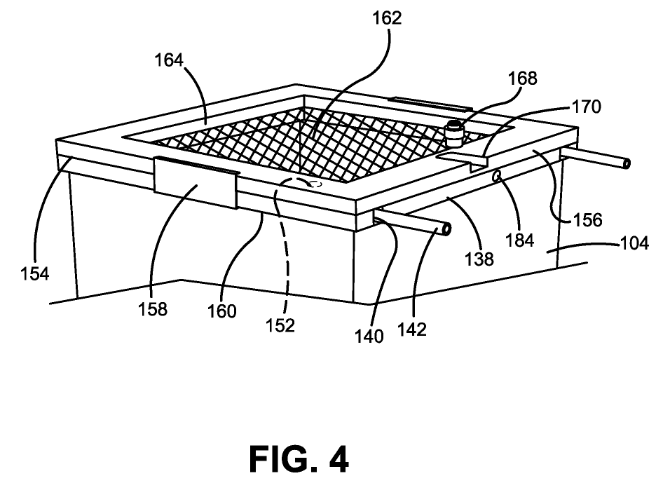

The top frame 138 may also be comprised of a plurality of magnets 148 distributed along the top surface 150 of the frame 138, either embedded flush or surface mounted, as seen in FIG. 5. The magnets 148 may interact with corresponding magnets 152 positioned on the bottom surface 154 of a lid 156 to create uniform contact and sealing between the lid 156 and the top frame 138, as seen in FIG. 4. The lid 156 may additionally be comprised of clamp style fasteners 158 such as but not limited to any combination of over center latches, spring clips, or twist locks that engage with exterior edges 160 of the top frame 138. A screen 162 may be integrated into the lid 156 and may be comprised of a fine mesh formed from metal, plastic, or fiberglass. The screen 162 may be tensioned within a frame 164 to maintain airflow, prevent animal escape, and resist deformation.

A receiving area 166 may be integrated into the top frame 138 and dimensioned to accept a humidifier hose via an adapter coupling 168 that is inserted through an opening 170 in the lid 156, as seen in FIG. 4. The bottom wall of the receiving area 166 may be covered by a barrier 172, as seen in FIG. 5, such as mesh or perforated screen to allow air passage while serving as a barrier to prevent animal escape.

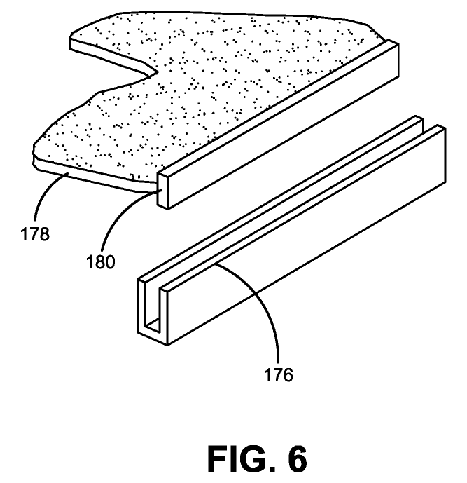

The interior space 174 of the body 104 may be comprised of one or more receiving points 176 such as but not limited to horizontal or vertical channels, grooves, or brackets configured to receive an artificial interior surface 178, as seen in FIG. 6. The artificial surface 178 may be comprised of an attachment fastener 180 such as but not limited to a lip, flange, or tongue that engages with the receiving point 176 to maintain a suspended position, as seen in FIG. 1. The receiving point 176 may run continuously around the perimeter of the interior space 174 or be segmented around the interior space 174 to allow for selective placement of the artificial surface 178. The artificial surface 178 may be repositioned along the receiving points 176 as desired and may be comprised of materials such as but not limited to textured plastic or other materials capable of receiving habitat elements or accessories.

The bottom surface 180 of the top frame 138 may be comprised of integrated lighting elements 182 which may include any combination of but not limited to UVB emitting bulbs, visible spectrum LED arrays, or incandescent heat lamps. The lighting elements 182 may be independently controlled via at least one button 184 or linked to the timer 118 for automated operation.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-purpose animal enclosure device” and “device” are interchangeable and refer to the multi-purpose animal enclosure device 100 of the present invention.

Notwithstanding the foregoing, the multi-purpose animal enclosure device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multi-purpose animal enclosure device 100 as shown in the FIGS. are for illustrative purposes only, and that many other sizes and shapes of the multi-purpose animal enclosure device 100 are well within the scope of the present disclosure. Although the dimensions of the multi-purpose animal enclosure device 100 are important design parameters for user convenience, the multi-purpose animal enclosure device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-purpose animal enclosure device comprising:
a bottom frame member comprised of a power outlet;
a body extending upward from the bottom frame member, wherein the body forms an interior space;
wherein the body is comprised of a quick-detach receiving point;
wherein the body is comprised of a door that is attached to the body via an articulating member
a power cord;
a timer module electrically connected to the power outlet;
a quick detach receiving point in fluid communication with the body and configured to receive a drainage hose via a quick connector;
a top frame comprised of a channel and a first magnet;
a tubing comprised of a misting head, wherein the tubing is positioned within the channel; and
a lid comprising a screen, a fastener, and a second magnet for magnetic engagement with the first magnet.

2. The multi-purpose animal enclosure device of claim 1 further comprised of a writing surface positioned on the bottom frame member.

3. The multi-purpose animal enclosure device of claim 2, wherein the writing surface is comprised of a dry-erase surface.

4. The multi-purpose animal enclosure device of claim 1, wherein the articulating member is comprised of a rail or a hinge.

5. The multi-purpose animal enclosure device of claim 1, wherein the door is comprised of a gasket.

6. The multi-purpose animal enclosure device of claim 1, wherein the door is comprised of a securing mechanism.

7. A multi-purpose animal enclosure device comprising:
a bottom frame member comprised of a power outlet;
a body extending upward from the bottom frame member, wherein the body forms an interior space;
wherein the body is comprised of a quick-detach receiving point;
wherein the body is comprised of a door that is attached to the body via an articulating member
a power cord;
wherein the interior space is comprised of a receiving point configured to receive an attachment fastener of an artificial interior surface;
a timer module electrically connected to the power outlet;
a quick detach receiving point in fluid communication with the body and configured to receive a drainage hose via a quick connector;
a top frame comprised of a channel and a first magnet;
a tubing comprised of a misting head, wherein the tubing is positioned within the channel; and
a lid comprising a screen, a first fastener, and a second magnet for magnetic engagement with the first magnet.

8. The multi-purpose animal enclosure device of claim 7, wherein the misting head is comprised of an adjustable nozzle head.

9. The multi-purpose animal enclosure device of claim 7, wherein the top frame is comprised of a receiving area for a humidifier hose.

10. The multi-purpose animal enclosure device of claim 7 further comprised of a writing surface that attaches to the bottom frame member via a second fastener.

11. A multi-purpose animal enclosure device comprising:
a bottom frame member comprised of a power outlet;
a body extending upward from the bottom frame member, wherein the body forms an interior space;
wherein the body is comprised of a quick-detach receiving point;
wherein the body is comprised of a door that is attached to the body via an articulating member
a power cord;
a lighting element;
wherein the interior space is comprised of a receiving point configured to receive an attachment fastener of an artificial interior surface;
a timer module electrically connected to the power outlet;
a quick detach receiving point in fluid communication with the body and configured to receive a drainage hose via a quick connector;
a top frame comprised of a channel and a first magnet;
a tubing comprised of a misting head, wherein the tubing is positioned within the channel; and
a lid comprising a screen, a fastener, and a second magnet for magnetic engagement with the first magnet.

12. The multi-purpose animal enclosure device of claim 11, wherein the light element is controlled by a button.

13. The multi-purpose animal enclosure device of claim 11, wherein the light element is controlled by the timer module.

14. The multi-purpose animal enclosure device of claim 11, wherein the timer module is comprised of an interval control.

15. The multi-purpose animal enclosure device of claim 11 further comprised of a switch that controls the light element and the power outlet.

16. The multi-purpose animal enclosure device of claim 11, wherein the body is comprised of a transparent material.

17. The multi-purpose animal enclosure device of claim 11, wherein the fastener of the lid engages the top frame.

18. The multi-purpose animal enclosure device of claim 17, wherein the fastener is comprised of a clip or a clamp.

19. The multi-purpose animal enclosure device of claim 11 further comprised of an adapter coupling for a humidifier hose.

20. The multi-purpose animal enclosure device of claim 11, wherein the receiving point is comprised of a channel, a groove, or a bracket.
